(19) United States
(12) Patent Application Publication
(10) Pub. No.: US 2011/0180674 A1
(43) Pub. Date: Jul. 28, 2011

(54) Display Mount

(76) Inventors: Robert P. Bliven, Saratoga, CA (US); Ray Gradwohl, Saratoga, CA (US)

(21) Appl. No.: 12/693,425

(22) Filed: Jan. 25, 2010

(51) Int. Cl. F16M 11/04; F16M 11/22; F16M 13/00

(52) U.S. Cl. 248/121; 248/176.1; 248/398

(57) ABSTRACT

A display mount system including a hinge, a leaf and a fastener. The hinge can be attached to the display. The leaf can extend from the hinge. The leaf can include a fastener to connect the leaf to a receiver. The receiver can be a base or a mounting bracket.

### BACKGROUND

A display stand can be adjustable to allow a user to ergonomically place the display for use. A display may be able to tilt or raise and lower to optimize the placement of the display in an ergonomic position. If a display can tilt forward and backward the display mount may include hinges that attach to the base. The hinges can be attached to both the display and the base with screws to support the weight of the display or the hinge may not be removable from the display or the base. A display may include openings on the back used to attach the display to mounting brackets. The mounting brackets that can be attached to the opening on the back of the display may be 100 millimeters apart in a square pattern known as the Video Electronics Standards Association (VESA) standard. The mounting brackets may be a swing arm or a wall bracket.

### BRIEF DESCRIPTION OF THE DRAWINGS

Some embodiments of the invention are described with respect to the following figures:

FIG. 1 is a display according to an example embodiment of the invention;

FIG. 2 is a base according to an example embodiment of the invention;

FIG. 3a is a mounting bracket according to an example embodiment of the invention;

FIG. 3b is a mounting bracket according to an example embodiment of the invention;

FIG. 4 is a mounting bracket according to an example embodiment of the invention;

FIG. 5 is a system according to an example embodiment of the invention; and

FIG. 6 is a method according to an example embodiment of the invention.

### DETAILED DESCRIPTION

A panel used in a display to display images can be made in different thicknesses and weights depending on the technology of the panel. For example a Liquid Crystal Diode LCD panel has at least the LCD layer and a backlight layer and an Organic Light Emitting Diode Panel has just the diode layer. As the panel technology becomes thinner the display enclosures supporting the panels cannot be reduced because of inclusion of standards such as VESA mounting.

The VESA standard increases the thickness of the display enclosure by having openings to screw fasteners on the back of the display enclosure. The opening may have a depth of about 1 cm to allow the mounting bracket to securely attach to the display enclosure adding an additional 2.5 cm to the thickness of the display enclosure. The additional 2.5 cm of thickness on the display enclosure can add additional costs to the display enclosure in additional materials and weight to the display and the packaging of the display.

The base and column for a VESA standard display has to be at least the distance between the openings on the back of the display and the bottom of the display. For example if the VESA opening on the display are in the midpoint of the back of the display, a stand may be at least one half as tall as the display. If the stand mounted lower on the back of the display the material for the stand may be reduced.

A display that attaches to a VESA base has an opening to attach the base. The base can include parts that allow the display to be adjusted: For example the base may include a hinge to allow the display to tilt if it is attached to the base. To replace the base with another type of support for the display, such as a wall mount, the wall mount bracket may use a hinge to allow the display to tilt relative to the wall mount bracket and the hinge would have to be on the wall mount bracket. Having a hinge on all the different mounts that the display can attach to can add to the cost of the display because a hinge is used on each stand or mounting bracket. Attaching a hinge to the display can allow the display to be adjusted irrespective of the base or mounting bracket the display is attached and can reduce the number of hinges because each mounting base or mounting bracket does not have to include a hinge for the display to be adjustable.

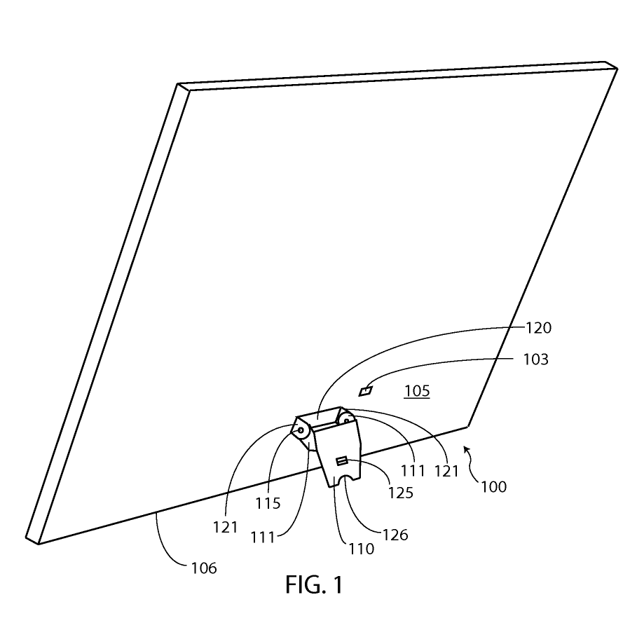

With reference to the figures, FIG. 1 is a display according to an example embodiment of the invention. The display 100 includes a hinge base 120 attached to the back 105 of the display 100. The hinge base 120 can have a knuckle 121 extending from the base 120. In one embodiment the hinge base 120 has a knuckle 121 at each end of the base 120.

A leaf knuckle 111 can be connected to the knuckle 121 by a pin 115. In one embodiment there can be a leaf knuckle 111 for each knuckle 121 on the base 120. If there is a leaf knuckle 111 for each knuckle 121 on the base then there may be a pin 115 for each connection between the knuckle 121 and the leaf knuckle 111. In an alternative embodiment the leaf knuckle 111 may extend between the knuckles 121 and the pin 115 may extend from the one knuckle 120 to another knuckle 120.

The leaf 110 can be one piece extending from the leaf knuckles 111 connected to the pin 115. The leaf 110 can extend from leaf knuckles 111 to the bottom 106 of the display 100. If the leaf 110 does not extend past the bottom 106 of the display 100, the display 100 may take up less space when packed for shipping. The leaf 110 can be flat so that the leaf 110 does not add additional thickness to the display 100. In one embodiment, flat means that the length and the width of the leaf are multiple times greater than the thickness of the leaf. For example if the leaf is 5 centimeters long and 5 centimeters wide the thickness may be 0.5 centimeters.

If the leaf 110 is supported by a base the weight of the display may cause the display to lean forward or backward until the display reached the end of the travel allowed by the hinge. Force may be applied to the hinge to counter the weight of the display. For example friction may provide a force that is capable of countering the force exerted by gravity on the display. The friction may be provided by a clutch between the knuckle 121 and the leaf knuckle 111. The clutch can have a spring to apply a force to a clutch plate causing friction between the clutch plate and the knuckle 121 or the leaf knuckle 111 to counter gravity on the display 100. In another embodiment a torsion spring can be used to counter gravity on the display 100. The torsion spring can surround the pin 115 and apply a force between the leaf 110 and the hinge base 120.

The leaf 110 can include a fastener 125 to lock the leaf 110 to a receiver. The fastener 125 may be an aperture in the leaf. In one embodiment the aperture is a cavity in the surface of the leaf 110 and in another embodiment the aperture is an opening extending through the leaf 110. The leaf 110 may include other types of fasteners for example a locking wedge or a threaded opening. In one embodiment, the leaf 110 may include multiple fasteners 125 on the leaf 110. In one embodiment, the leaf 110 may have a notch 126 in one edge of the leaf 110. For example the leaf 110 may have a notch 126 in the bottom edge of the leaf 110 to stabilize the leaf in a receiver.

In one embodiment the leaf 110 can have a rectangular shape or portion or alternatively a keystone, trapezoidal, or triangular shape or portion. For example the portion of the leaf 110 that is received by the receiver may have a keystone, trapezoidal, or triangular shape while the remaining portion of the leaf 110 has another shape. The keystone or trapezoidal leaf 110 can include the top and bottom of the leaf 110 being parallel to each other and at least a portion of the sides of the leaf 110 are not parallel. A leaf 110 with a triangular shape can have at least a portion of the sides of the leaf 110 that are not parallel to each other. A leaf 110 with a keystone, trapezoidal, or triangular shape can provide a stable connection to a receiver by exerting force on the receiver by the two sides of the leaf instead of the bottom of the leaf 110.

The display 100 may have a port 103 on the back 105 of the display 100. The port 103 may be used to connect the display to a power source for example an alternating current power receptacle or a data source such as a computing device. A computing device may be a portable computer, desktop computer, server computer, personal digital assistant, phone or another computing device. The port 103 be can configured so that a cable connected to the port 103 is perpendicular to the back 105 of the display 100. If the cable connected to the port 103 is perpendicular to the back 105 of the display 100, it is less likely that the cable may prevent adjustments made to the hinge leaf 110.

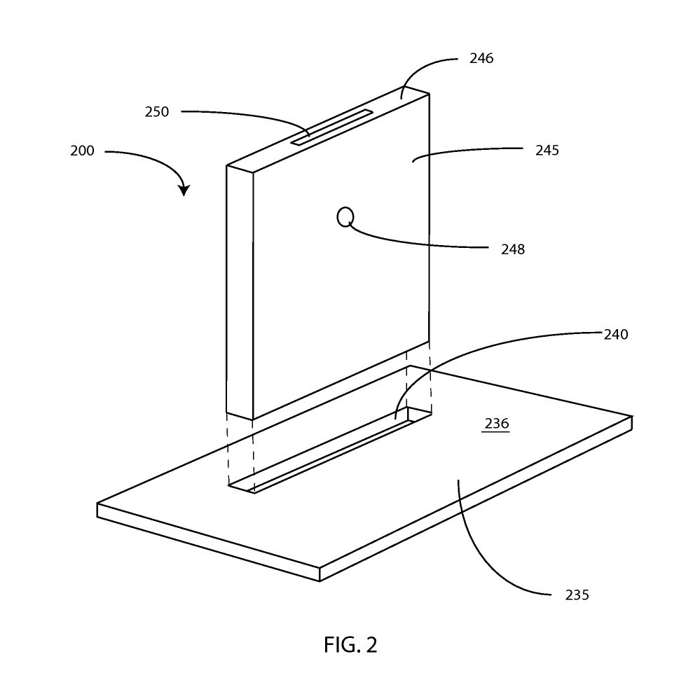

FIG. 2 is a base 200 according to an example embodiment of the invention. The base 200 can include a foot 235. The foot 235 can be a different shapes such as circular, square, rectangular or another shape. The foot 235 may have an opening 240 in the foot to receive the column 245. In one embodiment the foot 235 does not include an opening 240 and the column 245 is attached to the surface 236 of the foot 235. The column 245 may be fastened to the foot 235. The fastener may be for example screw or a quick release fastener. If the column is attached to the surface 236 of the foot a fastener is used to connect the column 245 to the foot 235. In one embodiment the fastener may include a release that can unlock the fastener to remove the column from the foot 235.

The column 245 can include an aperture 250 in the top 246 of the column 245. The aperture 250 can receive the leaf of the display. In one embodiment a column 245 includes the fastener and couples to the leaf fastener on the leaf of the display. If the column includes a fastener to couple to the leaf fastener of the display, the fastener can lock the column to the leaf until a release 248 is activated to unlock the coupling between the fastener in the column 245 and the leaf fastener. The column and the foot can be flat so that the length and the width of the column and the foot are multiple times greater than the thickness of the column and the foot. For example if the foot is 20 centimeters long and 20 centimeters wide the thickness may be 1 centimeter.

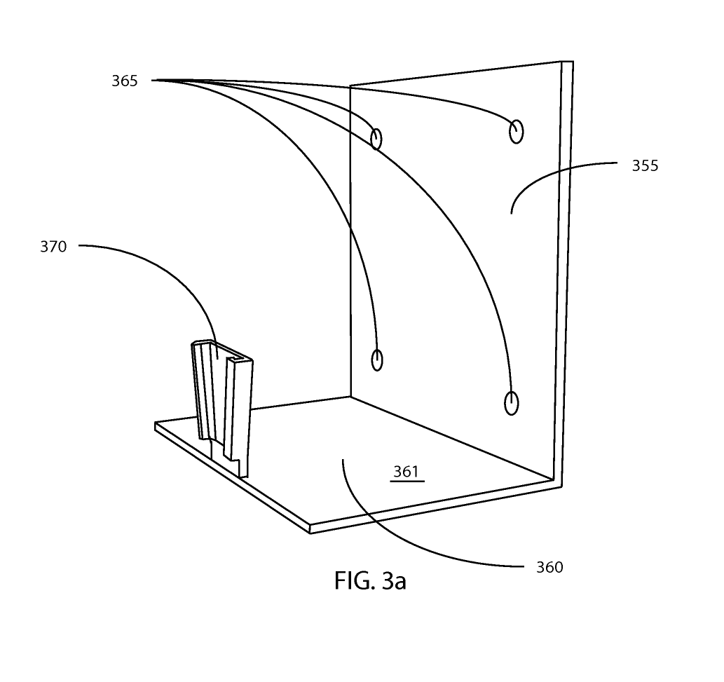

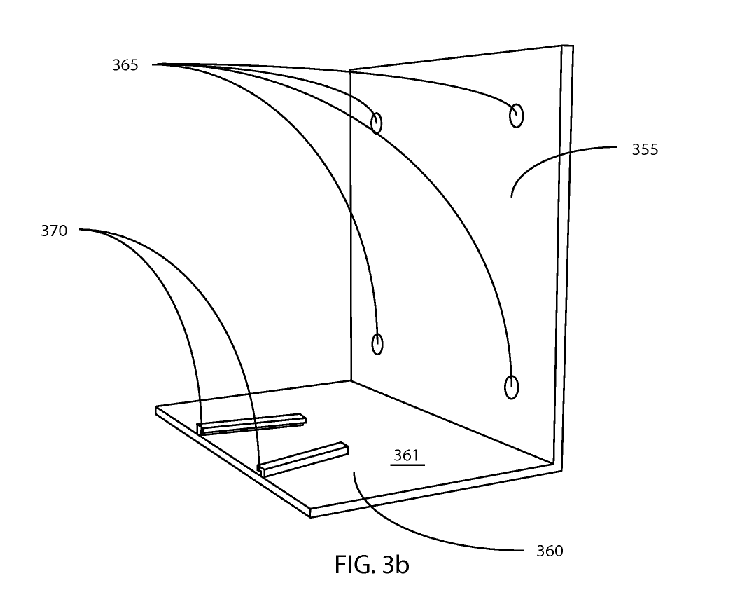

FIG. 3a is a mounting bracket according to an example embodiment of the invention. The mounting bracket 300 includes a first mounting plate 355. The mounting plate 355 can include an opening 365 to attach the mounting plate to another object, for example the opening 365 can be used to attach the mounting bracket 300 to a wall or to a display arm. In one embodiment there may be multiple openings 365 in the mounting plate 355 to attach the mounting plate 355 to a VESA compliant arm, base or another display support device. In one embodiment the openings 365 may be threaded to receive screws from a VESA compliant arm.

The mounting bracket 300 can include a support 360 that is connected to the mounting plate 355. The support 360 may be for example perpendicular to the mounting plate 355. The receiver 370 can be connected to the edge of the mounting plate 355. The receiver 370 can be for example at an obtuse angle to the surface 361 of the support 360. The receiver 370 can accept the leaf of the display. In one embodiment gravity and the weight of the display holds the leaf in the receiver 370. In one embodiment friction can hold the leaf in the receiver. In another embodiment the receiver 370 may include a fastener to lock the leaf in the receiver 370 and the fastener may have a release for the lock.

FIG. 3b is a mounting bracket according to an example embodiment of the invention. The mounting bracket can receive a leaf from a display. If the leaf on the display is connected to a hinge, the receiver 370 on the mounting bracket can be oriented at different angles relative to the support 360, for example the receiver 370 may include brackets attached to the support 360. In one embodiment the receiver can include a fastener to lock the leaf in the receiver if the force of gravity may not hold the leaf in the receiver. In one embodiment the support 360 is part of the receiver 370 and the leaf may be inserted between the receiver 370 and the support 360.

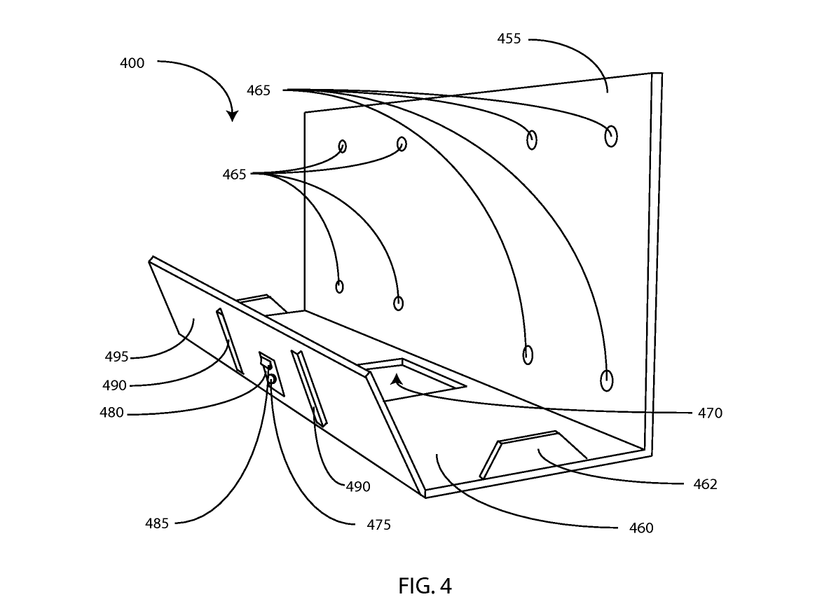

FIG. 4 is a mounting bracket according to an example embodiment of the invention. The mounting bracket 400 includes multiple mounting openings 465 to attach the mounting bracket 400 to an object. The openings on the mounting plate 455 may be used to attach accessories to the mounting bracket 400. For example a display that is attached to the mounting bracket 400 may use an external power adapter to supply direct current power to the display, the mounting bracket 400 can provide a place to set the external power adapter. The mounting brackets could also be used to mount devices such as a docking station, KVM (keyboard video mouse) switch, a computing system or another device.

In one embodiment the support 460 of the mounting bracket 400 can include a cable opening 470 in the support 460 to allow the cables that can connect to the display to pass through the bottom of the mounting bracket 400. In one embodiment the support 460 and the mounting plate 455 are connected by a hinge. The hinge can allow the mounting bracket to fold to reduce the volume of the packaging used for the mounting bracket 400. The support 460 can also be used to place devices such as a docking station, KVM (keyboard video mouse) switch, a computing system or another device. The support 460 may have a tab at the end of the support 460 to prevent a device from being moved off of the support 460 without lifting the device.

The mounting bracket 400 can include a receiving plate 495. The receiving plate can include leaf brackets 490 to insert the leaf of a display between. The leaf brackets 490 may be part of the receiving plate or may be removable to allow the mounting bracket to be adapted to different leafs.

The mounting bracket 400 may also include a fastener 485. The fastener 485 may be for example wedge shaped and may connect to a fastener in a leaf of a display if the leaf is inserted in the leaf brackets 490. In one embodiment the fastener 485 is supported by a flexible member 480. The flexible member can allow the fastener 485 to deflect if a leaf is inserted in the leaf brackets 490 and return to its undeflected position when the fastener 490 is aligned with the aperture in the leaf. In one embodiment the flexible member may also include a release 475 to deflect the fastener 485 to unlock the leaf from the leaf brackets 490. The release 475 may also stop the leaf from being inserted too far into the leaf brackets 490, in one embodiment. The release 475 may also stabilize the leaf in the leaf brackets 490 if the leaf is loose in the leaf brackets 490 and a notch may be included on the leaf to lessen the lateral movement of the leaf between the leaf brackets. The fastener 485, flexible member 480 and the release 475 may be removable with the leaf brackets 490 to adapt the mounting bracket to different leafs.

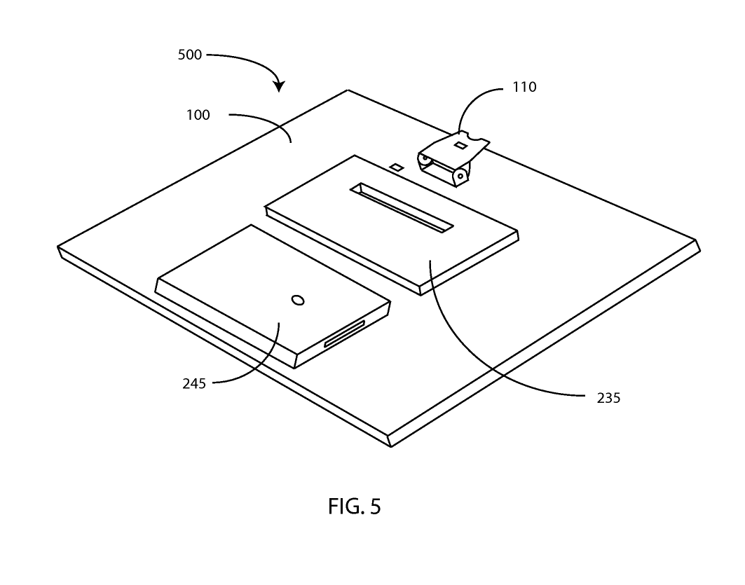

FIG. 5 is a display system 500 according to an example embodiment of the invention. The display system can include a display 100, a foot 235 and a column 245. The display 100 can include a leaf 110 extending from the hinge. The hinge can be adjusted so that the leaf 110 is for example parallel to the back 105 of the display 100 to reduce the thickness of the display if the display leaf is not attached to a base or a mounting bracket for shipping.

The foot 235 and the column 245 can be separated. In one embodiment the length and width of the foot 235 and the length and width of the column 245 can be less than the length and width of the display 100. For example if the display is 35 centimeters wide and 40 centimeters long the width of the foot and the column can be less than the 35 centimeters and the sum of the length of the foot and the length of the column can be less than 40 centimeters to allow the column 245 and the foot 235 to be placed on the back 105 of the display 100 to minimize the thickness of the display system and reduce the volume of the packaging and thus reduced the packaging.

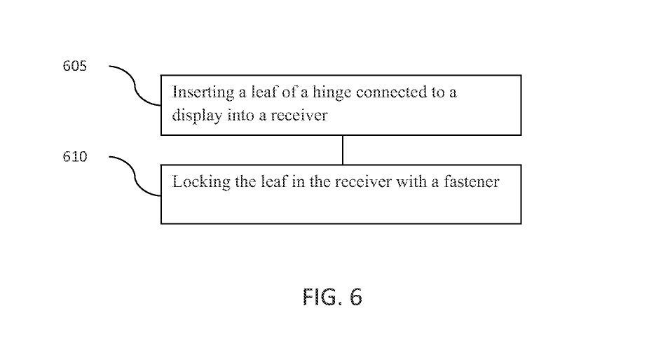

FIG. 6 is a method according to an example embodiment of the invention. The method begins by inserting a leaf of a hinge connected to a display into a receiver at 605. The leaf can be an extension of a knuckle of a hinge to reduce the number of parts in the display system. The leaf can be locked in the receiver with a fastener at 610. Locking the leaf to the receiver can be non-removable to prevent the leaf from coming out of the receiver or the leaf may have a release for unlocking the fastener to unlock the leaf from the receiver. In one embodiment releasing the fastener can include applying force by a user to the release and the force on the release deflects the fastener away from the fastener on the leaf.

If the leaf of the display is not connected to a receiver, the display can be flattened by adjusting the leaf. Flattening the display may include for example adjusting the hinge so that the leaf is parallel to the back of the display to reduce the overall thickness of the display and to reduce the volume of the packaging for the display.

If the leaf on the display is inserted in a receiver the display can be tilted by adjusting the hinge between the display and the leaf. Tilting the display can provide a user an ergonomic position in which to view the display. The display may be tilted relative to a base with a receiver that rests on a surface, for example a desk, or the display may be tilted relative to a mounting bracket with the hinge.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A display mount system comprising:
a hinge attached to the display;
a leaf as an extension of the hinge; and
a fastener included in the leaf to connect the leaf to a receiver.

2. The system of claim 1, wherein the leaf is flat.

3. The system of claim 1, further comprising a column attached to a foot.

4. The system of claim 3, further comprising an aperture in the column to receive the leaf.

5. The system of claim 3, wherein the column is removable from the foot.

6. The system of claim 3, further comprising a locking wedge to engage the fastener in the leaf.

7. The system of claim 6, further comprising a release to disengage the locking wedge from the fastener in the leaf.

8. The system of claim 6, further comprising a flexible member, wherein the flexible member supports the locking wedge.

9. The system of claim 1, wherein a portion of the leaf has a keystone, trapezoidal or triangular shape.

10. The system of claim 1, wherein sides of the leaf are not parallel to each other.

11. The system of claim 1, further comprising a mounting bracket with multiple openings in the first side and a receiver on a second side to connect to the leaf, wherein the first side and the second side are connected by a support.

12. The system of claim 11, wherein the support has an opening aligned with cable ports on the display.

13. A method comprising:
inserting a leaf of a hinge connected to a display into a receiver; and
locking the leaf in the receiver with a fastener.

14. The method of claim 13, further comprising releasing the fastener to unlock the leaf from the receiver.

15. The method of claim 14, further comprising flattening the display by adjusting the leaf without the receiver attached.

16. The method of claim 14, further comprising tilting the display by adjusting the hinge between the display and the leaf.

17. A display mount system comprising:
a mounting plate with a hole;
an extension is connected to the mounting plate; and
a receiver to receive a leaf from a display.

18. The display mount system of claim 17 further comprising a leaf attached to a hinge, wherein if the leaf is connected to the receiver then a display attached to the hinge can pivot at the hinge.

19. The display mount system of claim 17 wherein the mounting plate has at least 4 holes in a VESA configuration.

20. The display mount system of claim 17 further comprising a hinge between the mounting plate and the extension.
